(19) United States
(12) Patent Application Publication
(10) Pub. No.: US 2004/0007099 A1
(43) Pub. Date: Jan. 15, 2004

(54) One-way wrench

(76) Inventor: Yung-Chung Hsu, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/195,296

(22) Filed: Jul. 15, 2002

(51) Int. Cl. B25B 13/46

(52) U.S. Cl. 81/60

(57) ABSTRACT

A wrench includes a head, a gear, an engagement element and a bent spring. The head defines a circular space and a crescent space communicated with the circular space. The gear includes a plurality of teeth, and is received in the circular space. The engagement element includes a concave face formed with a plurality of teeth and a convex face, and is received in the crescent space. The teeth of the engagement element are engaged with some of the teeth of the gear. The convex face contacts a wall of the crescent space. The bent spring includes a first section and a second section, and is received in the crescent space so that the first section of the spring contacts the wall of the crescent space and the second section of the spring contacts the engagement element. When the head is rotated in a first direction, the gear tends to rotate the engagement element relative to the head in a second position opposite to the first direction so as to enhance the engagement of the teeth so as to avoid rotation of the head relative to the gear. When the head is rotated in the second direction, the gear rotates the engagement element in the first direction relative to the head since the convex face is not hindered via the wall of the crescent space, thus disengaging the teeth of the engagement element from the teeth of the gear, thus allowing rotation of the head relative to the gear.

### BACKGROUND OF INVENTION

1. Field of Invention

The present invention relates to a one-way wrench.

2. Related Prior Art

Taiwan Patent Publication No. 281946 teaches a one-way wrench including a head 10, an annular gear 20, an engagement block 13 and a spring 14. The head 10 defines a circular space 11 and a crescent space 111 communicated with the circular space 11. A wall of the crescent space 111 defines a recess 112. The annular gear 20 includes an external face formed with a plurality of teeth 23 and an internal face 24 for engagement with a nut or a head of a bolt. The engagement block 13 includes a convex face formed with a boss 131 and a concave face formed with a plurality of teeth 132. The spring 14 includes an end receiving the boss 131. The engagement block 13 and the spring 14 are received in the crescent space 111. Normally, the teeth 132 are engaged with some of the teeth 23. The convex face contacts the wall of the crescent space 111. As the head 10 is rotated in a first direction, the annular gear 20 engaged with the nut or the head of the bolt tends to rotate the engagement element 13 in a second direction opposite to the first direction relative to the head 10, thus enhancing the contact of the convex face with the wall of the crescent space 111 and the engagement of the teeth 132 with the teeth 23. Thus, rotation in the first direction of the head 10 relative to the annular gear 20 is avoided. Therefore, the head 10 rotates the annular gear 20 in the first direction together the nut or the head of the bolt clockwise. When the head 10 is rotated in the second direction, the annular gear 20 engaged with the nut or the head of the bolt is allowed to rotate the engagement element 13 in the first direction relative to the head 20 because the convex face is not hindered by means of the wall of the crescent space 111. Thus, the teeth 132 can be disengaged from the teeth 23 in order to allow rotation of the head 10 relative to the annular gear 35. Therefore, rotation of the head 10 in the second direction does not cause rotation of the annular gear 20 in the second direction together with the nut or the head of the bolt.

Taiwan Patent Publication No. 335750 teaches a one-way wrench including a head, an annular gear 35, an engagement block 40, a base 50 and a spring 60. The head defines a crescent space 31 and a circular space 32 and communicated with the crescent space 31. A wall of the crescent space 31 defines a recess 34. The annular gear 35 includes an internal face for engagement with a nut or a head of a bolt and an external face formed with a plurality of teeth 52. The engagement block 40 includes a plurality of teeth and a convex face and defines a recess. The base 50 defines a channel and includes a convex face and a boss 51 formed on the convex face. The spring 60 includes an end received in the recess defined in the engagement block 40 and an opposite end inserted in the channel defined in the base 50. The engagement block 40, the base 50 and the spring 60 are received in the crescent space 31. The boss 51 is received in the recess 34. The annular gear 35 is received in the circular space 32. Normally, the teeth of the engagement block 40 are engaged with some of the teeth of the annular gear 35. The convex faces contact the wall of the crescent space 31. As the head is rotated in a first direction, the annular gear 35 engaged with the nut or the head of the bolt tends to rotate the engagement element 40 in a second direction opposite to the first direction relative to the head, thus enhancing the contact of the convex face of the engagement block 40 with the wall of the crescent space 31 and the engagement of the teeth of the engagement block 40 with the teeth of the annular gear 35. Thus, rotation in the first direction of the head relative to the annular gear 35 is avoided. Therefore, the head rotates the annular gear 35 in the first direction together with the nut or the head of the bolt. When the head is rotated in the second direction, the annular gear 35 engaged with the nut or the head of the bolt is allowed to rotate the engagement element 40 in the first direction relative to the head because the convex face of the engagement block 40 is not hindered by means of the wall of the crescent space 31. Thus, the teeth of the engagement block 40 can be disengaged from the teeth of the annular gear 35 so as to allow rotation of the head relative to the annular gear 35. Therefore, rotation of the head in the second direction does not cause rotation of the annular gear 35 in the second direction together with the nut or the head of the bolt. Fabrication and mounting the base 50 require effort and therefore increase its cost.

Taiwan Patent Publication No. 431260 teaches a one-way wrench including a head 20, an annular gear 50, an engagement block 30, a seesaw 40 and a spring 44. The head 20 defines a circular space 22 and a crescent space 23 communicated with the circular space 22. The annular gear 50 includes an internal face for engagement with a nut or a head of a bolt and an external face formed with a plurality of teeth 52. The engagement block 30 includes a plurality of teeth 32 and a convex face 34 and defines a recess 35. The seesaw 40 includes a convex face 41, two corners 42 and an end 43. The spring 44 includes an end fit in the recess 35 and an opposite end in which the end 43 of the spring 44 is fit. The engagement block 30, the seesaw 40 and the spring 44 are movably received in the crescent space 23. The annular gear 50 is received in the circular space 22. When the head 20 is rotated in a first direction, the annular gear 50 contacts one of the comers 42, thus pivoting the engagement block 30 to the annular gear 50. Thus, the teeth 32 are engaged with some of the teeth 52 so that the annular gear 50 engaged with the nut or the head of the bolt tends to rotate the engagement element 30 in a second direction opposite to the first direction relative to the head 10, thus enhancing the contact of the convex face 34 with the wall 24 and the engagement of the teeth 32 with the teeth 52. Therefore, rotation in the first direction of the head 20 relative to the annular gear 50 is avoided. The head 20 rotates the annular gear 50 in the first direction together with the nut or the head of the bolt. When the head 20 is rotated in the second direction, the annular gear 50 contacts both the comers 42 so as to pivot the engagement block 30 from the annular gear 50. Thus, the teeth 32 are disengaged from the teeth 52 so as to allow rotation of the head 20 relative to the annular gear 50. Therefore, rotation of the head 20 in the second direction does not cause rotation of the annular gear 50 in the second direction together with the nut or the head of the bolt. The engagement element 30 may not be engaged with or disengaged from the annular gear 50 as desired since the engagement element 30, the seesaw 40 and the spring 44 can slide together in the crescent space 23. Moreover, fabrication and installment of the seesaw 40 requires effort and therefore increase its cost.

The present invention is therefore intended to obviate or at least alleviate the problems encountered in prior art.

### SUMMARY OF INVENTION

It is the primary objective of the present invention to provide a one-way wrench that is simple in structure and low in cost.

According to the present invention, a one-way wrench includes a head, a gear, an engagement element and a bent spring. The head defines a circular space and a crescent space communicated with the circular space. The gear includes a plurality of teeth, and is received in the circular space. The engagement element includes a concave face formed with a plurality of teeth and a convex face, and is received in the crescent space. The teeth of the engagement element are engaged with some of the teeth of the gear. The convex face contacts a wall of the crescent space. The bent spring includes first and second sections, and is received in the crescent space so that the first section of the spring contacts the wall of the crescent space and the second section of the spring contacts the engagement element. When the head is rotated in a first direction, the gear tends to rotate the engagement element relative to the head in a second direction opposite to the first direction so as to enhance the engagement of the teeth so as to avoid rotation of the head relative to the gear. When the head is rotated in the second direction, the gear rotates the engagement element in the first direction relative to the head since the convex face is not hindered via the wall of the crescent space, thus disengaging the teeth of the engagement element from the teeth of the gear so as to allow rotation of the head relative to the gear.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a one-way wrench according to a first embodiment of the present invention;

FIG. 2 is an exploded view of the one-way wrench according to the first embodiment of the present invention;

FIG. 3 is a cross-sectional view of the one-way wrench in a driving mode according to the first embodiment of the present invention;

FIG. 4 is a cross-sectional view of the one-way wrench in an idle mode according to the first embodiment of the present invention;

FIG. 5 is an exploded view of a one-way wrench according to a second embodiment of the present invention;

FIG. 6 is a cross-sectional view of the one-way wrench in a driving mode according to the second embodiment of the present invention;

FIG. 7 is a cross-sectional view of the one-way wrench in an idle mode according to the second embodiment of the present invention;

FIG. 8 is a perspective view of a one-way wrench according to a third embodiment of the present invention;

FIG. 9 is an exploded view of the one-way wrench according to the third embodiment of the present invention; and

FIG. 10 is a perspective view of a one-way wrench according to a fourth embodiment of the present invention.

### DETAILED DESCRIPTION OF PREFERRED EMBODIMENT

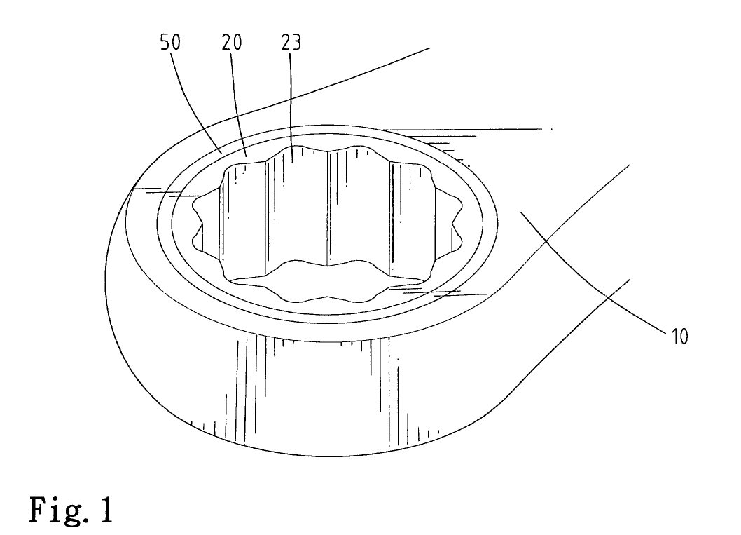

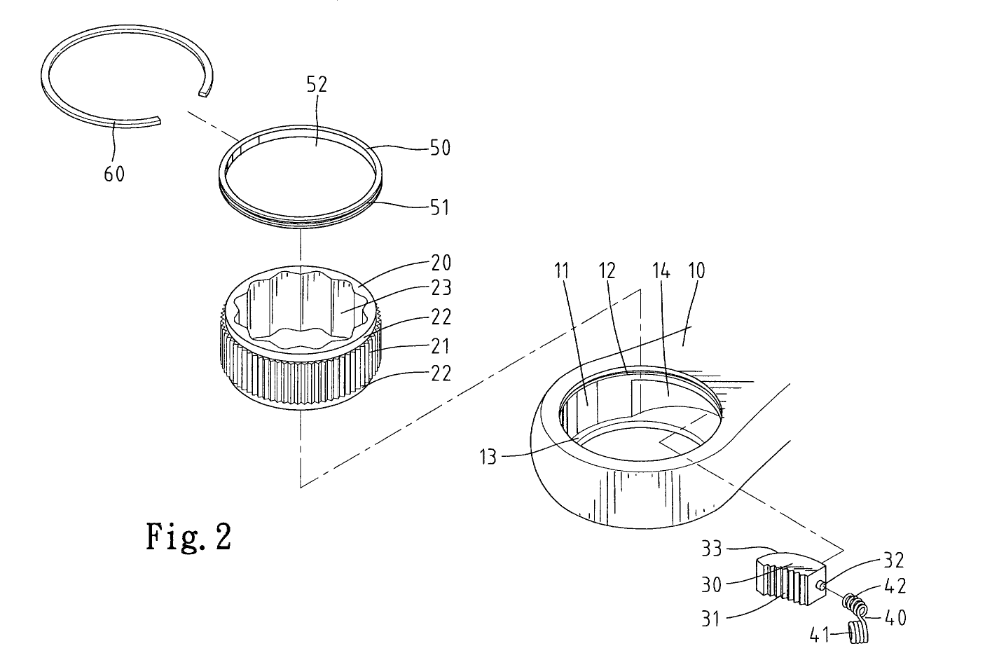

FIGS. 1-4 show a one-way wrench according to a first embodiment of the present invention. The wrench includes a head 10, an annular gear 20, an engagement element 30, a spring 40, an O-ring 50 and a C-ring 60.

The head 10 defining a circular space 11 and a crescent space 14 communicated with the circular space 11. A groove 12 is defined in a wall of the circular space 11 near an upper face of the head 10. A rim 13 is formed on the wall of the circular space 11 at a lower face of the head 10.

The annular gear 20 includes an external face formed with a plurality of teeth 21 and upper and lower shanks 22 and an internal face 23 for engagement with a nut or a head of a bolt.

The engagement element 30 includes a plurality of teeth 31 formed on a first face, a boss 32 formed on a second face next to the first face and a convex face 33.

The spring 40 includes a bent configuration consisting of a first helical section 41 and a second helical section 42. An axis of the first helical section 41 of the spring 40 and an axis of the second helical section 42 of the spring 40 lie in a same plane. The first helical section 41 includes a free end 411 and a periphery 412.

The O-ring 50 defines a groove 51 in an external face and a circular hole 52.

In assembly, the boss 32 is forced into the second helical section 42 of the spring 40. The engagement element 30 and the spring 40 are received in the crescent space 14. The annular gear 20 is received in the circular space 11. The lower shank 22 is positioned within the rim 13. The lower rim 22 acts as a shaft and the rim 13 acts as a bearing. The free end 411 of the first helical section 41 of the spring 40 contacts the annular gear 20. The C-ring 60 is expended so that an internal edge thereof can be received in the groove 51. Then, the C-ring 60 is pressed into the groove 51 so that the O-ring 50 and the C-ring 60 can be mounted onto the upper shank 22 and into the circular space 11. On alignment with the groove 12, an external edge of the C-ring 60 snaps into the groove 12. The internal edge of the C-ring 60 remains in the groove 51. Thus, the O-ring 50 is retained on the head 10 by means of the C-ring 60. The upper shank 22 acts as a shaft and the O-ring 50 acts as a bearing.

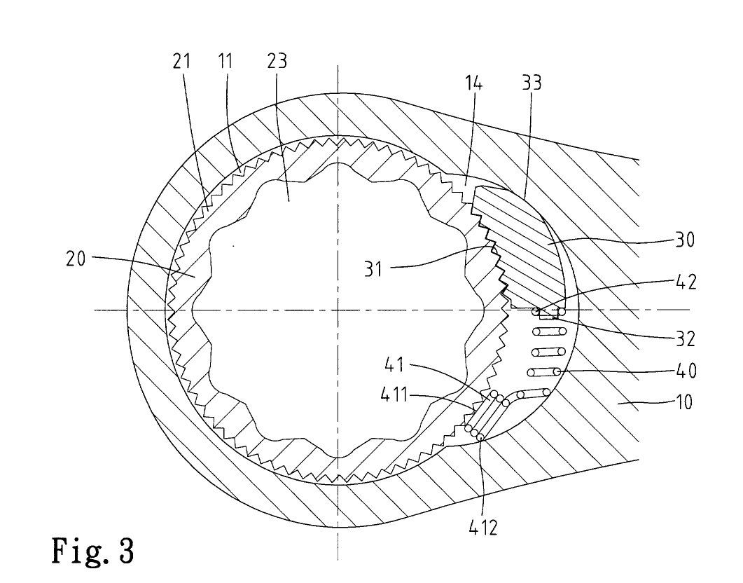

Referring to FIG. 3, the teeth 31 are engaged with some of the teeth 21. The convex face 33 is in contact with a wall of the crescent space 14. Although not shown, a nut or a head of a bolt is engaged with the annular gear 20. When the head 10 is rotated clockwise, the annular gear 20 engaged with the nut or the head of the bolt tends to rotate the engagement element 30 counterclockwise relative to the head 10. This tendency enhances the contact of the convex face 33 with the wall of the crescent space 14 and the engagement of the teeth 31 with the teeth 21. Thus, this tendency is hindered and clockwise rotation of the head 10 relative to the annular gear 20 is avoided. Therefore, the head 10 rotates the annular gear 20 clockwise together with the nut or the head of the bolt.

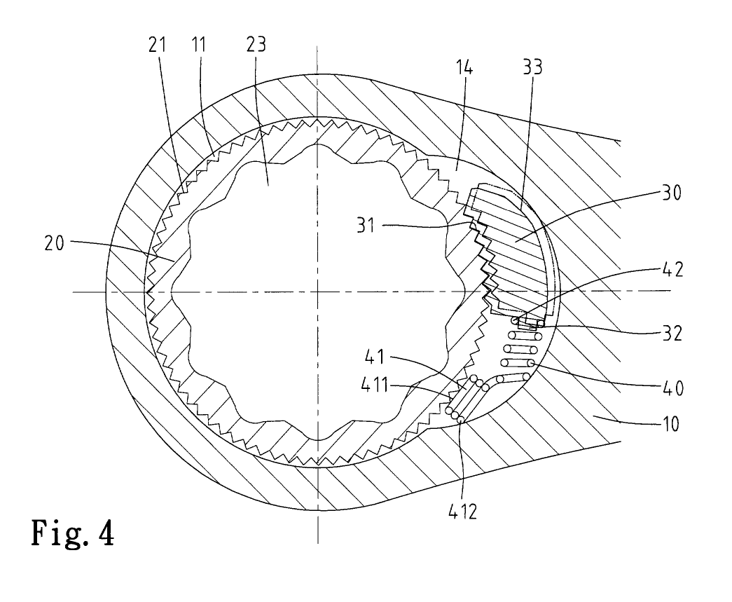

In FIG. 4, when the head 10 is rotated counterclockwise, the annular gear 20 engaged with the nut or the head of the bolt rotates the engagement element 30 clockwise relative to the head 10 because the convex face 33 is not hindered by means of the wall of the crescent space 14. Thus, the teeth 31 can be disengaged from the teeth 21 so as to allow counterclockwise rotation of the head 10 relative to the annular gear 20. Therefore, counterclockwise rotation of the head 10 does not cause counterclockwise rotation of the annular gear 20 together with the nut or the head of the bolt clockwise. The annular gear 20 retains the first helical section 41 of the spring 40 in contact with the wall of the crescent space 14. Therefore, when the head 10 is released, the spring 40 return the engagement element 30 into engagement with the annular gear 50.

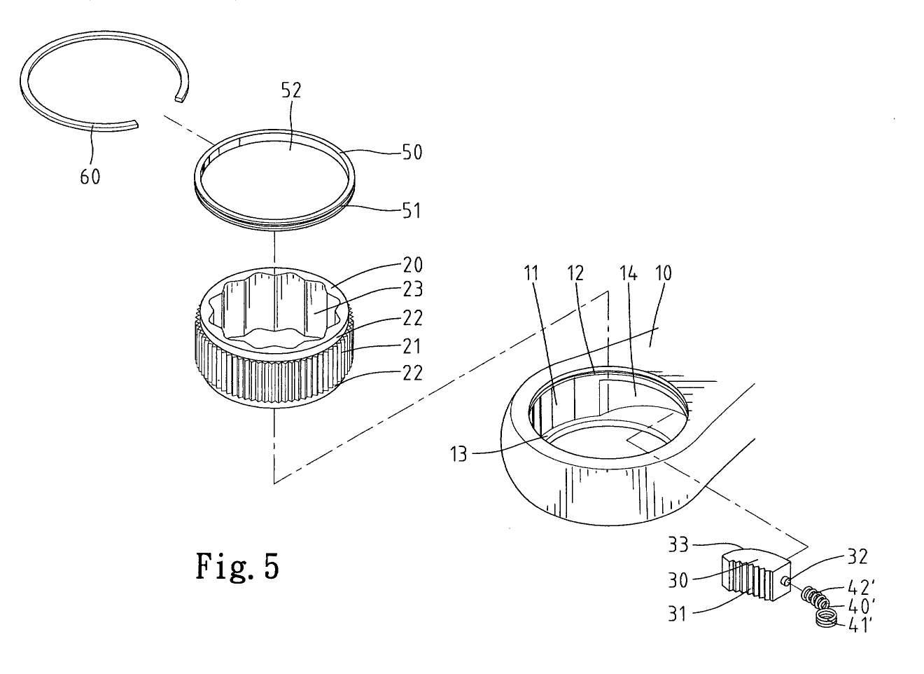

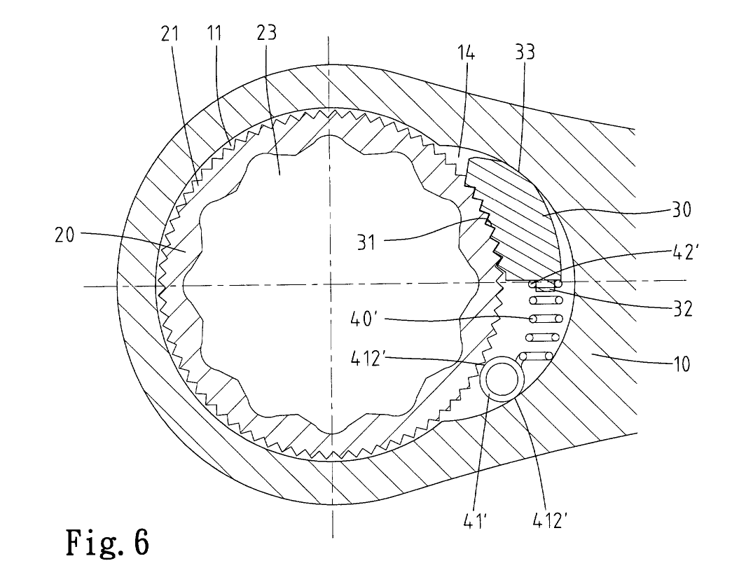

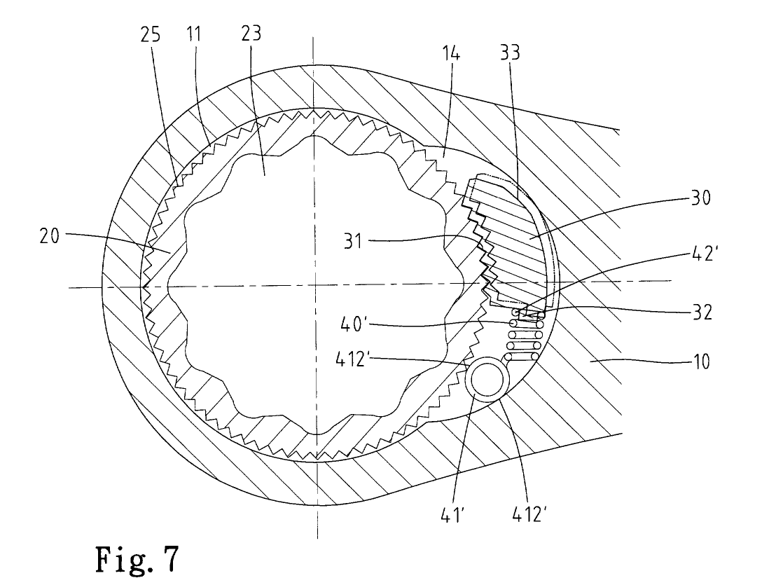

FIGS. 5˜6 show a one-way wrench according to a second embodiment of the present invention. The second embodiment is identical to the first embodiment except for including a spring 40′ instead of the spring 40. Like the spring 40, the spring 40′ includes a bent configuration consisting of a first helical section 41′ and a second helical section 42′. However, an axis of the first helical section 41′ of the spring 40′ and an axis of the second helical section 42′ of the spring 40′ do not lie in a same plane. The first helical section 41′ of the spring 40′ includes a free end 411′ and a periphery 412′. As best shown in FIGS. 6 and 7, when the spring 40′ is received in the crescent space 14, the periphery 412′ of the first helical section 41′ of the spring 40′ contacts the wall of the crescent space 14 and some of the teeth 21. The teeth 21 will not be trapped in the first helical section 41′ of the spring 40′. Such trapping will hinder counterclockwise rotation of the head 10 relative to the annular gear 20 and is not desirable.

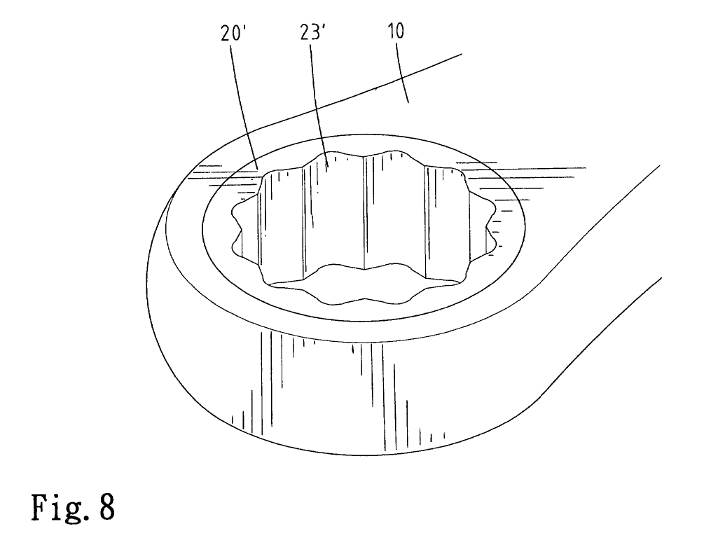

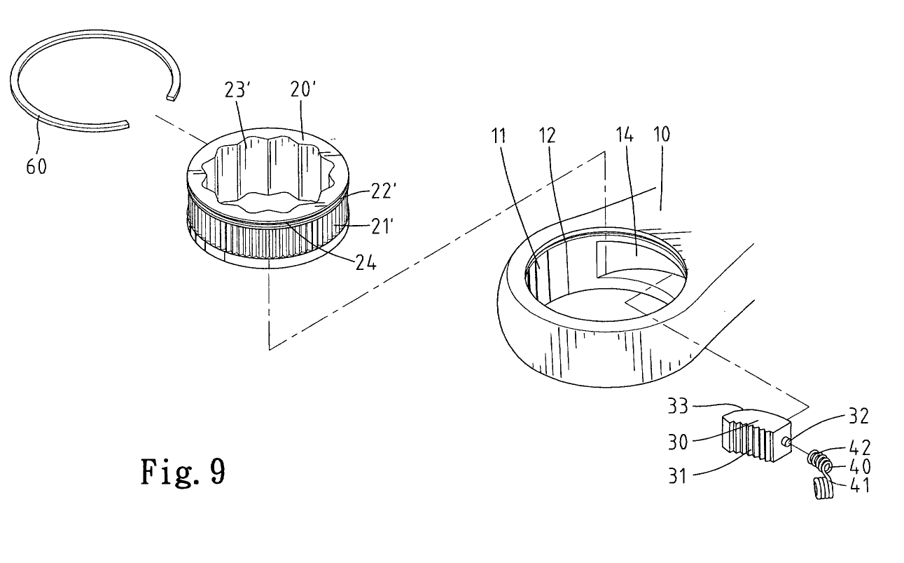

FIGS. 8 and 9 show a one-way wrench according to a third embodiment of the present invention. The third embodiment is identical to the first embodiment except for including an annular gear 20′ instead of the annular gear 20 and not including an O-ring such as the O-ring 50 and not including a rim such as the rim 13. The annular gear 20′ is identical to the annular gear 20 except for including an upper shank 22′ defining a groove 24. In the third embodiment, the C-ring 60 is received in the groove 24 like it is received in the groove 51 in the first embodiment. In the third embodiment, the C-ring 60 is received in the groove 24 same as it is received in the groove 51 in the first embodiment. A rotational connection of the head 10 of the annular gear 20′ is made possible. Therefore, a rim such as the rim 13 is no longer necessary to support the annular gear 20′.

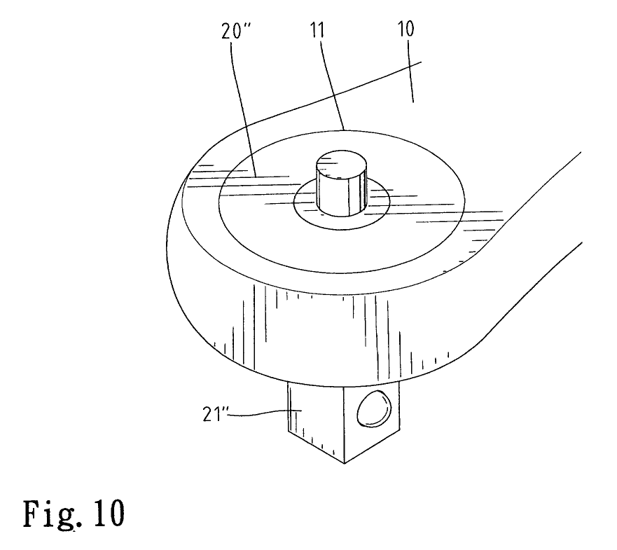

FIG. 10 shows a one-way wrench according to a fourth embodiment of the present invention. The fourth embodiment is identical to the first embodiment except for including an annular gear 20″ instead of the annular gear 20. The annular gear 20″ is engaged with a mandrel 25 which in turn can be engaged with a socket for driving a nut or a head of a bolt.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A wrench including a head (10) defining a circular space (11) and a crescent space (14) communicated with the circular space (11), a gear (20; 20′) including a plurality of teeth (21) and being received in the circular space (11), an engagement element (30) including a concave face formed with a plurality of teeth (31) and a convex face (33) and being received in the crescent space (14) so that the teeth (31) of the engagement element (30) are engaged with some of the teeth (21) of the gear (20; 20′) and that the convex face (33) contacts a wall of the crescent space (14), a bent elastic element (40) including a first section (41) and a second section (42) and being received in the crescent space (14) so that the first section (41) of the elastic element (40) contacts the wall of the crescent space (14) and that the second section (42) of the elastic element (40) contacts the engagement element (30), wherein:
when the head (10) is rotated in a first direction, the gear (20; 20′) tends to rotate the engagement element (30) relative to the head (10) in a second direction opposite to the first direction so as to enhance the engagement of the teeth (31; 21) so as to avoid rotation of the head (10) relative to the gear (20; 20′); and
when the head (10) is rotated in the second direction, the gear (20; 20′) rotates the engagement element (30) relative to the head (10) in the first direction since the convex face (33) is not hindered via the wall of the crescent space (14), thus disengaging the teeth (31) of the engagement element (30) from the teeth (21) of the gear (20; 20′) so as to allow rotation of the head (10) relative to the gear (20; 20′).

2. The wrench according to claim 2 wherein the bent elastic element (40; 40′) is a bent spring.

3. The wrench according to claim 2 wherein the first and second sections (41; 42) of the bent spring (40) are helical.

4. The wrench according to claim 3 wherein the first helical section (41) of the bent spring (40) includes a free end (411) in contact with the gear (20).

5. The wrench according to claim 3 wherein the first helical section (41′) of the bent spring (40′) includes a periphery (412′) in contact with the gear.

6. The wrench according to claim 3 wherein the engagement element (30) includes a boss (32) formed thereon for insertion in the second helical section (42; 42′) of the bent spring (40; 42′).

7. The wrench according to claim 1 wherein the head (10) includes a groove (12) defined in the wall of the circular space (11), and the gear (20) includes a shank (22) formed on the external face, and the wrench includes an O-ring (50) defining a groove (51) in an external face and being mounted on the shank (22) of the gear (20) and a C-ring (60) including an external edge received in the groove (12) defined in head (10) and an internal edge received in the groove (51) defined in the O-ring (50).

8. The wrench according to claim 1 wherein the head (10) includes a rim (13) formed on the wall of the circular space (11) for supporting the gear (20).

9. The wrench according to claim 8 wherein the gear (20) includes a shank (22) formed on the external face, the shank (22) of the gear (20) being positioned within the rim (13).

10. The wrench according to claim 1 wherein the gear (20; 20′) is an annular gear.

11. The wrench according to claim 1 wherein the gear (20″) includes a mandrel (25) for engagement with a socket.

12. The wrench according to claim 1 wherein the head (10) defines a groove (12) in the wall of the circular space (11), and the gear (20′) defines a groove (24), and the wrench includes a C-ring (60) including an external edge received in the groove (12) defined in head (10) and an internal edge received in the groove (24) defined in the gear (20′).
